(19) United States
(12) Patent Application Publication
(10) Pub. No.: US 2007/0025238 A1
(43) Pub. Date: Feb. 1, 2007

(54) Maintaining services of a network element

(75) Inventors: Jeff Miller, Arlington Heights, IL (US); Larry Cohn, Lake Zurich, IL (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/174,394

(22) Filed: Jul. 1, 2005

(51) Int. Cl. H04J 1/16

(52) U.S. Cl. 370/216

(57) ABSTRACT

A communication network (100) has a network element (102), and a remote controller (104). The network element exchanges data packets with other network elements, and is programmed to store (202) telephony configuration information as updates are made thereto, transmit (210) an operational status to a remote controller monitoring operations of the network element, transmit (212, 214) an alarm to the remote controller when an interruption in service is detected, and restore (216) operations of the network element according to the last recorded telephony configuration information. The remote controller is programmed to transmit (306, 308) an alarm notice to a service agent upon detecting a communication interruption event at the network element.

### FIELD OF THE INVENTION

This invention relates generally to fault-tolerant network services, and more particularly to maintaining services of a network element.

### BACKGROUND OF THE INVENTION

The advent of the Internet has created a mass distribution of packetized network elements (such as, for example, the Cisco™ CallManager™), which provide a number of services ranging from voice traffic, data traffic, video traffic, multimedia traffic, and combinations thereof, just to mention a few. Network elements are thus growing in software and hardware complexity. It is also becoming exceeding important to manage in a robust manner configuration information used for provisioning network elements in a widespread network supporting high packet traffic.

Large service providers generally must program network elements according to the provider's network configuration. Thus, vendors of network elements provide the network equipment and leave it up to the discretion of the service provider to manage network services according to configurations established by the service provider. Consequently, not many vendors of network elements provide backup systems, and those that do, are providing systems that can be awkward to use, expensive, and not configured for any particular customer application. More importantly, since vendors do not partake in providing network services, they cannot provide a holistic solution for maintaining services of a network element on an on-going basis.

### SUMMARY OF THE INVENTION

Embodiments in accordance with the invention provide a method and apparatus for maintaining services of a network element.

In a first embodiment of the present invention, a communication network has a network element, and a remote controller. The network element exchanges data packets with other network elements, and is programmed to store telephony configuration information as updates are made thereto, transmit an operational status to a remote controller monitoring operations of the network element, transmit an alarm to the remote controller when an interruption in service is detected, and restore operations of the network element according to the last recorded telephony configuration information. The remote controller is programmed to transmit an alarm notice to a service agent upon detecting a communication interruption event at the network element.

In a second embodiment of the present invention, a communication network operates according to a method having the steps of storing telephony configuration information in the network element as updates are made thereto, transmitting from the network element an operational status directed to the remote controller for monitoring operations of the network element, transmitting from the network element an alarm directed to the remote controller when an interruption in service is detected by the network element, restoring operations of the network element upon detecting the interruption in service according to the last recorded telephony configuration information, and transmitting from the remote controller an alarm notice directed to a service agent upon detecting a communication interruption event at the network element.

In a third embodiment of the present invention, a communication network has a network element, a remote controller, and a corresponding plurality of computer-readable storage mediums. The plurality of storage mediums include computer instructions for storing telephony configuration information in the network element as updates are made thereto, transmitting from the network element an operational status directed to the remote controller for monitoring operations of the network element, transmitting from the network element an alarm directed to the remote controller when an interruption in service is detected by the network element, restoring operations of the network element upon detecting the interruption in service according to the last recorded telephony configuration information, and transmitting from the remote controller an alarm notice directed to a service agent upon detecting a communication interruption event at the network element.

### BRIEF DESCRIPTION OF THE DRAWINGS

FIG. 1 is block diagram of a communication network according to an embodiment of the present invention;

FIG. 2 is block diagram of a network element of the communication network according to an embodiment of the present invention; and

FIGS. 3-4 depict flow charts of methods operating in the communication network according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

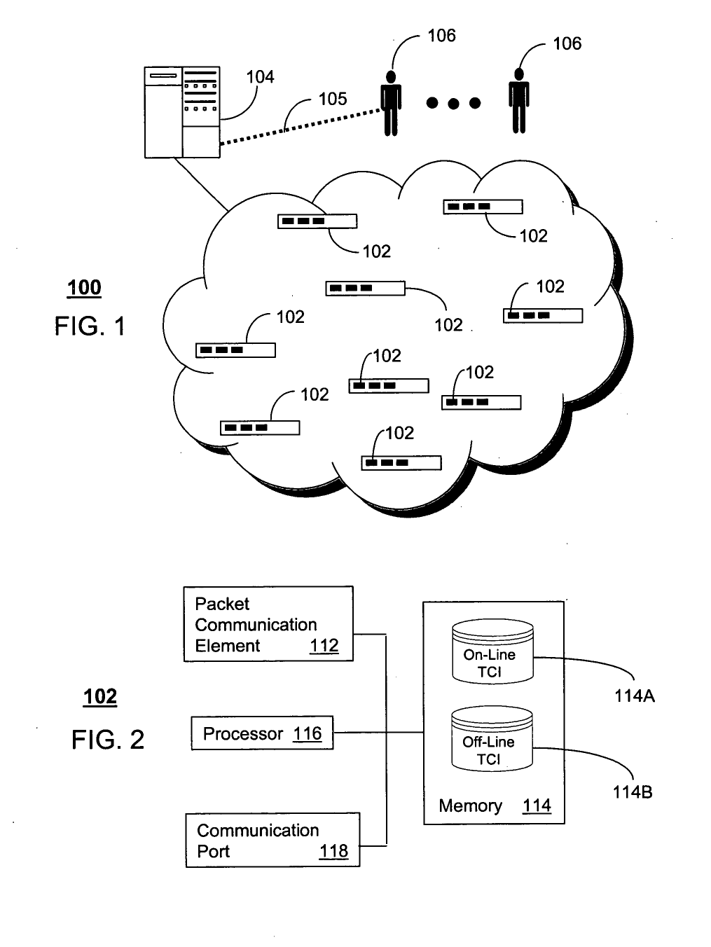

FIG. 1 is block diagram of a communication network 100 according to an embodiment of the present invention. The communication network 100 comprises network elements 102 for exchanging data packets between them, and a remote controller 104 coupled to at least one of the network elements 102 for monitoring services thereof. The communication network 100 can provide, for example, an Internet service offered by a service provider to customers spread about a number of geographic regions, or can be localized to a specific enterprise for Intranet and Extranet communications. It will be appreciated that any network configuration utilizing one or more network elements 102 is suitable for the present invention, and thereby is within the claimed invention.

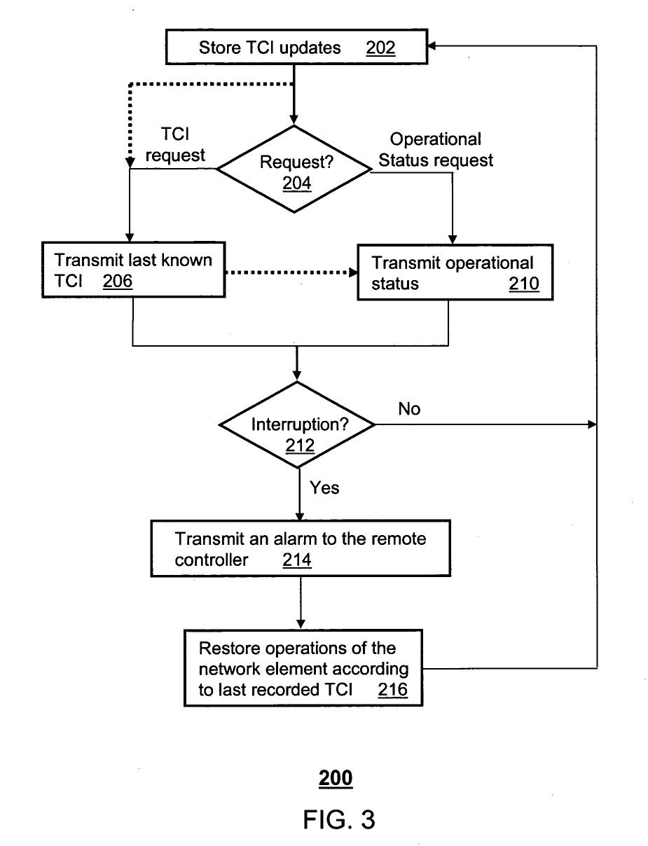

FIG. 2 is block diagram of the network element 102 of the communication network 100 according to an embodiment of the present invention. The network element 102 can comprise a packet communication element 112, a communication port 118, a memory 114 and a processor 116. The packet communication element 112 can utilize any conventional technology for exchanging data packets between network elements 102. The packet communication element 112 can support, for example, a number of communication functions including, but not limited to, VoIP (Voice over Internet Protocol), video communications, multimedia communications, IP communications, MPLS (Multi-Protocol Label switching), IVR (Interactive Voice Response) services, VPN (Virtual Private Network) services, ATM (Asynchronous Transfer Mode) services, FR (Frame Relay) services, DSL (Digital Subscriber Line) services, Ethernet services, or combinations thereof. The packet communication element 112 can utilize existing conventional communication technologies such as, for example, the Cisco™ CallManager™ to offer one or more of the foregoing services.

The communication port 118 utilizes conventional communication technology such as a PSTN (Public Switched Telephone Network), an IP (Internet Protocol) network, or wireless cellular network for communicating with the remote controller 104. Alternatively, the network element 102 can communicate with the remote controller 104 by way of the packet communication element 112 while services therein remain active.

The memory 114 utilizes two or more conventional media devices (such as a high capacity disk drive) for storage purposes and can be used as on-line and off-line databases 114A-B for managing telephony configuration information (hereinafter referred to as TCI). The memory 114 can also be used for storing computer instructions for directing the operations of the processor 116 in accordance with the present invention. It will be appreciated that the memory 114 can also use other media storage types such as floppy disks, CD-ROMs, Flash memories, non-volatile ROM, and/or RAM.

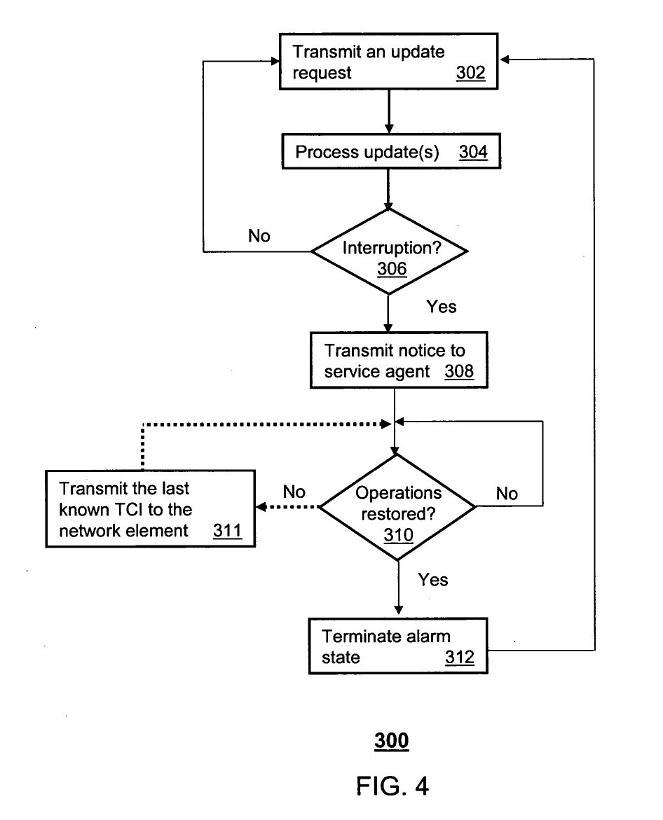

The processor 116 utilizes conventional computing technology such as one or more microprocessors and/or DSPs (Digital Signal Processor). The processor 116 controls operations of the packet communication element 112, the communication port 118, and the memory 114 in accordance with the present invention as will be described shortly in the flowcharts illustrated in FIGS. 3 and 4.

The remote controller 104 can be embodied in any conventional computing technology such as a server or standalone desktop computer that includes enough storage capacity to contain one or more images of the TCI of each network element 102 served by the remote controller 104 as will be explained shortly. The remote controller 104 can also communicate with any number of service agents 106 who are responsible for maintaining service of the network elements 102. Any conventional communication means 105 such as email, over-the-air (OTA) text messages, OTA voice messages, a paging message, or combinations thereof can be used to notify one or more service agents 106 of an alarm event pertaining to one or more of the network elements 102 monitored by the remote controller 104.

FIGS. 3-4 depict flow charts of methods 200 and 300 operating in the communication network 100 according to an embodiment of the present invention. The network element 102 operates according to method 200, while the remote controller 104 operates according to method 300.

Method 200 begins with step 202 where the network element 102 stores the TCI in the on-line and off-line TCI databases 114A and 114B as updates are made thereto. This step can be the result of network updates performed by the service provider as a result of changes made to the communication network 100 in the ordinary course of business. The off-line database 114B serves as a backup storage facility for the TCI, and can be used for restoration purposes during a service interrupt as will be described shortly. It should be noted that the off-line database 114B can be a simple and inexpensive hard disk media with a simple interface (such as a USB port) for coupling to the processor 116 of the network element 102. Additionally, the maintenance of TCI updates between the on-line and off-line databases 114A-B can be accomplished with conventional software backup utilities supplied by vendors such as Veritas™.

In step 204 the network element 102 checks for a request from the remote controller 104. If a TCI request is detected, the network element 102 transmits in step 206 the last known TCI update recorded by the network element 102. If on the other hand, an operation status request is detected, then the network element 102 transmits in step 210 an operation status to the remote controller 104. In an alternate embodiment, the network element 102 can be programmed to proceed to steps 206 and 210 without interim step 204 as indicated by the dashed lines of FIG. 3. The operational status can include any operational information useful to the remote controller 104 for monitoring the operational health of the network element 102. For example, the operational status can be a simple “I'm alive” message, or complex messages indicating operational conditions such as bit error rate, packet drop rate, frequency of queue overflow, and/or other packet traffic metrics.

In step 212, the network element 102 checks for an interruption in service at the network element 102. If no interruption is detected, the network element 102 proceeds to step 202 restarting the aforementioned process. An interruption in service can be any detectable event including, but not limited to, a power interruption, the capacity of the memory 114 falling below an acceptable operating threshold, a corruption in the TCI, an interruption in communications with the remote controller 104, and/or an interruption in communications with other network elements 102. These events may or may not be catastrophic. That is, the network element 102 may experience a portion or all of its operations disabled by one or more of these interruptions. It will be appreciated by an artisan with ordinary skill in the art that the network element 102 can be programmed to detect a number of other detectable service interruptions without departing from the scope and spirit of the claimed invention.

Upon detecting a service interruption, the network element 102 transmits in step 214 an alarm to the remote controller 104. The alarm can provide details of the interruption, or simply indicate that an interruption has been detected. Depending on the extent of the interruption, the network element 102 proceeds to step 216 to restore operations according to the last recorded TCI. If operations are indeed restored, the network element 102 proceeds to repeat steps 202 through 212.

FIG. 4 depicts the remote controller 104 operating according to method 300 in accordance with an embodiment of the present invention. Method 300 begins with step 302 where the remote controller 104 transmits an update request to the network element 102. The update request can ask for any kind of update from the network element 102 pertinent to monitoring the operational health of said element. For instance, the update request can be a request for an operational status of the network element 102, and/or a request for the last known TCI recorded by the network element 102. The operational status request can be a simple “Are you alive inquiry” versus a more complex request calling for a telemetry response from the network element 102. In step 304 the remote controller 104 processes updates transmitted by the network element 102 by storing TCI updates and/or analyzing the operational status information.

In step 306 the remote controller 104 checks for any one of a number of communication interruption events including, but not limited to, a failure to receive the operational status from the network element 102 requested in step 302 within a first period of time, receiving an alarm from the network element 102, detecting a communication anomaly in the operational status received in step 304 from the network element 102, and a failure of the network element 102 to restore operations within a second period of time. The time limits noted in these examples can be set at the discretion of the service provider. For example, if the network element 102 fails to respond to a request with 30 seconds, a communication interruption event is detected in step 306. Similarly, if after an alarm is received from the network element 102 and said element is unable to restore operations within 60 seconds a communication interruption event is detected by step 306. If, on the other hand, no interruption is detected, then the remote controller 104 proceeds to step 302 restarting the monitoring process.

Upon detecting an interruption, the remote controller 104 proceeds to step 308 where it transmits an alarm notice to a service agent 106. As mentioned above, the notice can be submitted by any communication means such as email, a text message to, for example, a cellular phone, a voice message (such as a pre-recorded voice alarm), a page, and/or combinations thereof. Said notice can include, for example, state information of the network element 102, and/or a request directing the service agent to the site of the network element 102 for servicing if the network element 102 is unable to restore operations autonomously.

The state information can include any information that can be useful to the service agent 106 for diagnosing and remedying the service interruption of the network element 102. In step 310, the remote controller 104 checks whether operations have been restored autonomously by the network element 102, or by the service agent 106. If neither condition is true, then the remote controller 104 maintains the current alarm state. In an alternative embodiment, the remote controller 104 transmits in step 311 a last known update of the TCI to the network element 102. This step can be invoked for any number of reasons including an autonomously transmission by the remote controller 104 after a timeout period, upon request of the network element 102 if the TCI is corrupt, or upon request of the service agent 106 attempting to restore operations remotely or at the site of the network element 102. Once operations have been restored, the remote controller 104 proceeds to step 312 where it terminates the alarm state and returns to step 302 to continue monitoring operations of the network element 102.

It should be evident by now that the present invention can be realized in hardware, software, or a combination of hardware and software. Moreover, the present invention can be realized in a centralized fashion, or in a distributed fashion where different elements are spread across several interconnected processors. Any kind of computing device or other apparatus adapted for carrying out method 200 described above is suitable for the present invention. Additionally, the present invention can be embedded in a computer program product, which comprises all the features enabling the implementation of method 200, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form.

It should be also evident that the present invention may be used for many applications. Thus, although the description is made for particular arrangements and methods, the intent and concept of the invention is suitable and applicable to other arrangements and applications not described herein. Accordingly, modifications and/or additions can be made to method 200 and/or method 300 without departing from the scope of the invention. For instance, steps 204 and 206 can be eliminated from method 200. Similarly, method 300 can be reduced to steps 306 and 308. It would be clear therefore to those skilled in the art that there are many potential modifications that can be effected on the disclosed embodiments without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A communication network, comprising:
a network element for exchanging data packets with other network elements is programmed to:
store telephony configuration information as updates are made thereto;
transmit an operational status to a remote controller monitoring operations of the network element;
transmit an alarm to the remote controller when an interruption in service is detected; and
restore operations of the network element according to the last recorded telephony configuration information; and
the remote controller is programmed to transmit an alarm notice to a service agent upon detecting a communication interruption event at the network element.

2. The communication network of claim 1, wherein the communication interruption event is at least one among a group of events comprising a failure to receive the operational status from the network element within a first period of time, receiving the alarm from the network element, detecting a communication anomaly in the operational status received from the network element, and a failure of the network element to restore operations within a second period of time.

3. The communication network of claim 1, wherein the network element comprises
a packet communication element for exchanging data packets with other network elements;
a communication port for communicating with the remote controller;
a memory for storing the telephony configuration information of the packet communication element; and
a processor coupled to the packet communication element, the communication port, and the memory for controlling operations thereof, wherein the processor is programmed according to the foregoing steps.

4. The communication network of claim 3, wherein the packet communication element operates according to at least one among a group of communication functions comprising VoIP (Voice over Internet Protocol), video communications, multimedia communications, IP communications, MPLS (Multi-Protocol Label switching), IVR (Interactive Voice Response) services, VPN (Virtual Private Network) services, ATM (Asynchronous Transfer Mode) services, FR (Frame Relay) services, DSL (Digital Subscriber Line) services, and Ethernet services.

5. The communication network of claim 1, wherein the remote controller is programmed to transmit the alarm notice to the service agent according to at least one among a group of communication means comprising an email notice, an over-the-air text message, an over-the-air voice message, an over-the-air text and voice message, and a paging message.

6. The communication network of claim 1, wherein the interruption in service is at least one among a group of events comprising detecting a power interruption, detecting memory capacity below an operating threshold, detecting a corruption in the telephony configuration information, detecting an interruption in communications with the remote controller, and detecting an interruption in communications with other network elements.

7. The communication network of claim 1, wherein the network element is programmed to transmit updates of the telephony configuration information to the remote controller.

8. The communication network of claim 7, wherein the network element is programmed to transmit upon request of the remote controller a last known update of the telephony configuration information to the remote controller.

9. The communication network of claim 7, wherein the remote controller is programmed to transmit a last known update of the telephony configuration information to the network element.

10. The communication network of claim 1, wherein the remote controller is programmed to:
transmit an update request according to at least one among a group of requests comprising a request for the operational status of the network element, and a request for the last known telephony configuration information recorded by the network element;
detect a failure of the network element to respond to the request within a first period of time;
transmit the notice alarm to the service agent in response to the detected failure, wherein the notice alarm includes at least one among a group of notices comprising state information of the network element, and a request directing the service agent to the site of the network element for servicing if the network element is unable to restore operations autonomously; and
terminate alarm state upon at least one among a group of events comprising autonomous restoration of the network element, and restoration of the network element indicated by a response from the service agent.

11. In a communication network, a method comprising the steps of:
storing telephony configuration information in the network element as updates are made thereto;
transmitting from the network element an operational status directed to the remote controller for monitoring operations of the network element;
transmitting from the network element an alarm directed to the remote controller when an interruption in service is detected by the network element;
restoring operations of the network element upon detecting the interruption in service according to the last recorded telephony configuration information; and
transmitting from the remote controller an alarm notice directed to a service agent upon detecting a communication interruption event at the network element.

12. The method of claim 11, wherein the communication interruption event is at least one among a group of events comprising a failure to receive the operational status from the network element within a first period of time, receiving the alarm from the network element, detecting a communication anomaly in the operational status received from the network element, and a failure of the network element to restore operations within a second period of time.

13. The method of claim 11, wherein the network element operates according to at least one among a group of communication functions comprising VoIP (Voice over Internet Protocol), video communications, multimedia communications, IP communications, MPLS (Multi-Protocol Label switching), IVR (Interactive Voice Response) services, VPN (Virtual Private Network) services, ATM (Asynchronous Transfer Mode) services, FR (Frame Relay) services, DSL (Digital Subscriber Line) services, and Ethernet services.

14. The method of claim 11, comprising the step of transmitting the alarm notice to the service agent according to at least one among a group of communication means comprising an email notice, an over-the-air text message, an over-the-air voice message, an over-the-air text and voice message, and a paging message.

15. The method of claim 11, wherein the interruption in service is at least one among a group of events comprising detecting a power interruption, detecting memory capacity below an operating threshold, detecting a corruption in the telephony configuration information, detecting an interruption in communications between the network element and the remote controller, and detecting an interruption in communications between the network element and other network elements.

16. The method of claim 11, comprising the step of transmitting from the network element updates of the telephony configuration information to the remote controller.

17. The method of claim 16, comprising the step of transmitting upon request of the remote controller a last known update of the telephony configuration information to the remote controller.

18. The method system of claim 16, comprising the step of transmitting from the remote controller a last known update of the telephony configuration information to the network element.

19. The method of claim 11, comprising the steps of:
transmitting an update request from the remote controller to the network element according to at least one among a group of requests comprising a request for the operational status of the network element, and a request for the last known telephony configuration information recorded by the network element;
detecting at the remote controller a failure of the network element to respond to the request within a first period of time; and
transmitting from the remote controller the notice alarm to the service agent in response to the detected failure.

20. In a communication network comprising a network element, a remote controller, and a corresponding plurality of computer-readable storage mediums, the plurality of storage mediums comprising computer instructions for:
storing telephony configuration information in the network element as updates are made thereto;
transmitting from the network element an operational status directed to the remote controller for monitoring operations of the network element;
transmitting from the network element an alarm directed to the remote controller when an interruption in service is detected by the network element;
restoring operations of the network element upon detecting the interruption in service according to the last recorded telephony configuration information; and
transmitting from the remote controller an alarm notice directed to a service agent upon detecting a communication interruption event at the network element.
